(19) United States
(12) Patent Application Publication
(10) Pub. No.: US 2014/0262052 A1
(43) Pub. Date: Sep. 18, 2014

(54) DETAPING PROCESS FOR FOILS TAPED ON SEMICONDUCTOR WAFERS

(71) Applicant: EM MICROLECTRONIC-MARIN SA, Marin (CH)

(72) Inventor: Peter Jacob, Zurich (CH)

(73) Assignee: EM MICROLECTRONIC-MARIN SA, Marin (CH)

(21) Appl. No.: 13/795,206

(22) Filed: Mar. 12, 2013

(51) Int. Cl. B32B 43/00

(52) U.S. Cl. CPC B32B 43/006
USPC 156/703; 156/701

(57) ABSTRACT

The invention concerns a detaping process for a protective foil taped onto a front-side of a semiconductor wafer, this detaping process comprising the successive steps of:
A) introducing the wafer and the protective foil taped onto the front-side of the semiconductor wafer into an electrically dissipative liquid or into an electrically dissipative solid-state medium having a flowing behavior substantially similar to the one of a liquid;
B) removing the protective foil when the wafer is into the electrically dissipative liquid or into the electrically dissipative solid-state medium.

In another implementing mode, the detaping process comprises, during the removing of the protective foil, a spray of an electrically dissipative liquid in the region adjacent to the detaping line between the semiconductor wafer and the protective foil or an injection of an electrically dissipative liquid along this detaping line.

### FIELD OF THE INVENTION

The present invention concerns the domain of semiconductor wafers manufacturing, in particular the process of detaping protective foils taped onto the front side of semiconductor wafers before the back-grinding thinning process.

### BACKGROUND OF THE INVENTION

In order to prepare semiconductor wafers for the back-grinding thinning process, a self-adhesive foil is taped onto the front-side wafer surface. This allows fixing the wafer (front-side) in the back-grinding tool by a vacuum holder without damaging the sensitive structures.

After the back-grinding, the protective foil must be detaped. In some cases, this is done manually by fixing the polished wafer (backside) onto a vacuum chuck and manually stripping down the front-side foil. However, in most cases, automated detaping tools are used, where the protective foil is removed by first sticking a strong adhesive tape onto the protective foil and thereafter removing the adhesive tape together with the protective foil.

In both processes, the main problem is a high generation of electrostatic charging, which is very difficult to be controlled. Indeed, electronic wafers with integrated circuits are electrostatic surface discharge sensitive devices (ESDS). State-of-the-art equipments use self-regulating air ionizer bars, following in short distance the detaping line (or delaminating line) of the protective foil. However, these approaches are expensive, need ionizer maintenance and sometimes even reduce detaping speed in order to avoid excessive charging by high-speed detaping. Electrostatic surface discharges (ESD), which may appear from the charged foil, include high risks for device functionality and reliability. Attempts to replace standard protective foils by an antistatic foil failed due to the lack of mechanical stability (tear-resistance, etc) of antistatic materials

### SUMMARY OF THE INVENTION

The aim of the present invention is to overcome the drawbacks of the detaping processes of the prior art mentioned here-before.

Thus, a first implementation of the present invention concerns a detaping process for a protective foil taped onto a front-side of a semiconductor wafer, this detaping process comprising the successive steps of:

A) introducing the semiconductor wafer and the protective foil taped onto the front-side of the semiconductor wafer into an electrically dissipative liquid or into an electrically dissipative solid-state medium having a flowing behavior substantially similar to the one of a liquid;

B) removing the protective foil when the wafer is into said electrically dissipative liquid or into said electrically dissipative solid-state medium.

Thanks the electrically dissipative liquid or electrically dissipative solid-state medium which flows between the front-side of the semiconductor wafer and the protective foil when this protective foil is removed and thus fills the region adjacent the detaping or delaminating line, charges which are generated by the detaping at the surface of the semiconductor wafer and at the surface of the protective foil will immediately be neutralised in a soft and non-damaging manner. A fast and riskless detaping can thus be performed.

Substantially the same result can be obtained by the second implementation of the present invention which concerns a detaping process for a protective foil taped onto a front-side of a semiconductor wafer, this detaping process comprising, during the removing of the protective foil, a spray of an electrically dissipative liquid in the region adjacent to the detaping or delaminating line between the semiconductor wafer and the protective foil or an injection of an electrically dissipative liquid along this detaping or delaminating line.

The second implementation has the advantage over the first one not to necessitate the introduction of the wafer with its support in a basin filled with a conductive liquid.

### BRIEF DESCRIPTION OF THE DRAWINGS

The present invention will be described subsequently in more detail with reference to the attached drawing, given by way of examples, but in no way limited thereto, in which:

FIG. 1 schematically shows a classical detaping process;

FIG. 2 shows a first step of a first implementing mode of a detaping process according to the invention;

FIG. 3 shows a second step of the first implementing mode of a detaping process according to the invention; and

FIG. 4 schematically shows a variant of a second implementing mode of a detaping process according to the invention.

### DETAILED DESCRIPTION OF THE INVENTION

FIG. 1 schematically shows the known problem of electrostatic surface discharge in a classical detaping process. The semiconductor wafer 2 is covered by a protective foil 4 and both are placed on a support 6. A strong adhesive tape 8 is stuck onto this protective foil. By pulling back this adhesive tape, the protective foil is detaped/delaminated. Because the protective foil is made of an insulating material and is electrostatic active, the detaping step generates surface charges on the back surface of this foil in the region of the detaping/delaminating line 5 and thus also at the front surface of the wafer (charges of opposite sign). When a charged zone of the protective foil is removed away from the wafer, the capacitance increases and the induced voltage between this charged zone and the wafer surface also increases. High voltages are thus generated and micro-sparks occur. The discharge in the front surface of the wafer with a high voltage has a destroying effect for the integrated circuits of the wafer.

In a variant of a first implementation of the invention shown on FIGS. 2 and 3, the detaping process is made within a basin 12 filled with carbonised deionised water (DI-water), in particular slightly carbonised DI-water 10. The carbonisation makes the water slightly electrically conductive, so that any charge which is generated by the detaping will immediately be neutralised in a soft and non-damaging manner.

More generally, the detaping process according to a preferred variant of the first implementation of the invention comprises the successive steps of:

A) introducing the semiconductor wafer 2 and the protective foil 4 taped onto the front-side of the semiconductor wafer into an electrically dissipative liquid (FIG. 2);

B) removing the protective foil 4 when the wafer 2 is into the electrically dissipative liquid (FIG. 3).

It is to be noted that maintenance of the liquid bath needs less attention than that of a self-controlled ioniser bar.

In the variant shown on FIG. 2, before step A), the detaping process comprises a preliminary step wherein an adhesive tape 8 is stuck onto the protective foil 4. The step B) of this detaping process is performed by pulling the adhesive tape 8 which is bound with the protective foil 4, so that this protective foil is removed from the front-side of the semiconductor wafer 2.

In another variant of the first implementation of the invention, the semiconductor wafer is introduced, in step A), into an electrically dissipative solid-state medium having a flowing behavior substantially similar to the one of a liquid, and the removing of the protective foil 4 in step B) occurs into this electrically dissipative solid-state medium. Preferably, the electrically dissipative solid-state medium is formed by small balls of conductive material, in particular aluminium balls. For example, the diameter of the small balls is inferior to two millimeters (2 mm).

A variant of a second implementation of the invention is schematically shown on FIG. 4. This second implementation is characterized in that the detaping process comprises, during the removing of the protective foil 4, a spray of an electrically dissipative liquid in the region adjacent to the detaping or delaminating line 5 between the semiconductor wafer and the protective foil or an injection of an electrically dissipative liquid 11 along this detaping or delaminating line 5. In FIG. 4, the variant wherein the liquid is injected along the detaping or delaminating line 5 is represented. The injection of the liquid 11 is done through a nozzle 16 of a device 15 associated with a reservoir of electrically dissipative liquid and equipped with means for allowing this liquid to exit the nozzle 16 under a certain pressure. It is to be noted that the nozzle can have a movement parallel to the detaping or delaminating line 5 is order to have the liquid 11 along the whole detaping or delaminating line. In another variant, several nozzles distributed periodically along the detaping or delaminating line are provided. In a further variant, the injection nozzle has a slit extending parallel to the detaping or delaminating line 5. It is possible to optimize the quantity of needed liquid for neutralizing the surface charges generated by the detaping process. The liquid which does not remain on the wafer can be recuperated by means provided to that effect in the periphery of the wafer and/or of the support 6. As in the first implementation, in a variant, the electrically dissipative liquid is carbonized deionized water.

What is claimed is:

1. A detaping process for a protective foil taped onto a front-side of a semiconductor wafer, wherein this detaping process comprises the successive steps of:
A) introducing the semiconductor wafer and the protective foil taped onto the front-side of the semiconductor wafer into an electrically dissipative liquid or into an electrically dissipative solid-state medium having a flowing behavior substantially similar to the one of a liquid;
B) removing the protective foil when the semiconductor wafer is into said electrically dissipative liquid or into said electrically dissipative solid-state medium.

2. The detaping process according to claim 1, wherein the electrically dissipative liquid is carbonized deionized water.

3. The detaping process according to claim 1, wherein the electrically dissipative solid-state medium is formed by balls of conductive material.

4. The detaping process according to claim 3, wherein the diameter of the balls is inferior to two millimeters (2 mm).

5. The detaping process according to claim 1, wherein, before step A), the detaping process comprises a preliminary step wherein an adhesive tape is stuck onto the protective foil; wherein the step B) is performed by pulling the adhesive tape which is bound with the protective foil, so that this protective foil is removed from the front-side of the semiconductor wafer.

6. A detaping process for a protective foil taped onto a front-side of a semiconductor wafer, wherein this detaping process comprises, during the removing of the protective foil, a spray of an electrically dissipative liquid in a region adjacent to the detaping or delaminating line between the semiconductor wafer and the protective foil or an injection of an electrically dissipative liquid along this detaping or delaminating line.

7. The detaping process according to claim 6, wherein the electrically dissipative liquid is carbonized deionized water.
